(19) United States
(12) Patent Application Publication
(10) Pub. No.: US 2025/0180822 A1
(43) Pub. Date: Jun. 5, 2025

(54) FIBER OPTIC CONNECTOR AND ADAPTER

(71) Applicant: Senko Advanced Components, Inc., Hudson, MA (US)

(72) Inventors: Kazuyoshi TAKANO, Tokyo (JP); Chi Ho FAN, Kowloon (HK); Wing Chiu HO, Kowloon (HK); Joe WONG, Kowloon (HK)

(73) Assignee: Senko Advanced Components, Inc., Hudson, MA (US)

(21) Appl. No.: 18/969,247

(22) Filed: Dec. 4, 2024

Related U.S. Application Data
(60) Provisional application No. 63/606,218, filed on Dec. 5, 2023.

(51) Int. Cl. G02B 6/38

(52) U.S. Cl. CPC G02B 6/3825; G02B 6/3882; G02B 6/3885; G02B 6/3887; G02B 6/3893

(57) ABSTRACT

The fiber optic connector according to the present disclosure may include a main housing having a front end and a rear end opposite to the front end in a longitudinal direction, defining a passage extending from the front end to the rear end and having a top side and a bottom side; a ferrule carrying a plurality of fibers and accommodated in the passage; a latch provided on the top side of the main body and configured to release the connector from an adapter port; and a back post connected to the rear end of the main housing, wherein the main housing includes an adjustment mechanism to ensure the connector is inserted into the adapter port in a desired state.

### CROSS-REFERENCE TO RELATED APPLICATION

The present invention claims priority to U.S. Provisional Patent Application No. 63/606,218 filed on Dec. 5, 2023, titled “Fiber optic Connector and Adapter.” The disclosure of which is incorporated hereby by reference in its entirety.

### FIELD OF THE INVENTION

The present invention generally relates to fiber optic connectors with a single latch and fiber optic adapters thereof. More specifically, the present invention relates to fiber optic connectors that require less space assumption, such as SN BTW (Behind The Wall) connectors, and the fiber optic adapters thereof.

### BACKGROUND

The prevalence of the Internet has led to unprecedented growth in communication networks. Consumer demand for services and increased competition has caused network providers to continuously find ways to fulfill the increasing needs while reducing cost. Certain solutions have included deployment of high-density interconnect panels. High-density interconnect panels may be designed to consolidate the increasing volume of interconnections necessary to support the fast-growing networks into a compacted form factor, thereby increasing quality of service and decreasing costs such as floor space. However, the deployment of high-density interconnect panels is still advancing.

In communication networks, such as data centers and switching networks, numerous interconnections between mating connectors may be compacted into high-density panels. Panel and connector producers are required to optimize for such high densities by shrinking the connector size and/or the spacing between adjacent connectors on the panel. Thus, generally, more connectors are used in a high-density array. As the numbers of connectors in a switching network increases, the associated cost of creating the switching network increases correspondingly. A new lower cost connector (e.g., a behind-the-wall (BTW) connector) with a shorter length has been developed to achieve high density and maintain a low cost.

U.S. Pat. No. 12,038,613B2, assigned to the current applicant, describes a fiber optic connector with a reduced overall length, which includes a main housing accommodating two ferrules and having an external release latch to be attached and released from the adapter port.

A conventional fiber optic connector 100 is shown in FIG. 1. The fiber optic connector 100 includes a main housing 110, a ferrule 140, a boot 170 and a latch 180. The fiber optic connector 100 is shown as a female connector that does not have guide pins. The main housing 110 has a top surface 111 and a bottom surface 112 opposite the top surface 111, and the latch 180 is provided on the top surface 111. The main housing 110 also includes a guiding recess 119 to guide the insertion of the connector 100 into an adapter.

As shown in FIG. 2A, when inserting the fiber optic connector 100 into the fiber optic adapter 900, the latch 180 of the connector 100 contacts an interior wall of the fiber optic adapter 900, forcing a front portion of the connector 800 downwards due to its asymmetric structure. As connector 100 moves further into the adapter 900, the connector 100 deviates from its desired orientation and is inserted in an angled manner, i.e., an angle α is formed between its centerline CL and the horizontal axis A. The angle α is around 3 degrees and may be smaller than 3 degrees.

To facilitate a smooth insertion of the connector into the adapter, there is a clearance “c” between the connector and adapter housing, e.g., 0.1 mm, as shown in FIG. 2B. When the connector 100 is fully inserted into the adapter 900 and mates with another fiber optic connector 700, the tilt of the connector 100 still exists and the front portion of the connector housing 110 goes down while the rear portion of the connector housing goes up due to the clearance c between the connector and the adapter housing and the reaction forces resulted from the latch, as indicated in FIG. 2C. In this angled state, the upper portion of the endface of the ferrule 140 contacts the corresponding ferrule first and then the lower portion of the endface, causing the spring force unevenly applied to the ferrule 140. In detail, the upper portion of the ferrule 140 close to the latch 180 is given a proper force, while the lower portion of the ferrule 140 away from the latch 180 is not given a proper force, see FIG. 2D. This will harm the ferrule and reduce its lifetime.

### SUMMARY

In one aspect of the present invention, the fiber optic connector may include a main housing having a front end and a rear end opposite to the front end in a longitudinal direction, defining a passage extending from the front end to the rear end and having a top surface and a bottom surface; a ferrule carrying a plurality of fibers and accommodated in the passage; a latch provided on the top surface of the main body and configured to release the connector from an adapter port; and a back post connected to the rear end of the main housing, wherein the main housing includes an adjustment mechanism to ensure the connector is inserted into the adapter port in a desired state.

In an example, the adjustment mechanism includes a first adjustment part on the top surface and a second adjustment part on the bottom surface.

In an example, the first adjustment part includes a protrusion on the top surface of the main body adjacent to its rear end.

In an example, the first adjustment part includes a first tapered surface, and the second adjustment part includes a second tapered surface.

In an example, a first distance is defined between the top surface and a centreline of the connector, and a second distance is defined between the bottom surface and the centreline of the connector, wherein the first distance and second distance change inversely along the longitudinal direction.

Providing the adjustment mechanism on the main housing of the fiber optic connector minimizes the tilting of the fiber optic connector within the adapter to establish reliable and constant optical communication between the fiber optic connectors.

### BRIEF DESCRIPTION OF THE DRAWINGS

The present invention will become more fully understood with reference to the detailed description given hereinbelow and the accompanying drawings, which are given by illustration only, and thus are not meant to limit the present disclosure, and wherein:

FIG. 1 is a planar view of the conventional fiber optic connector,

FIG. 2A is a sectional view of the insertion of the fiber optic connector of FIG. 1 into a fiber optic adapter,

FIG. 2B is an enlarged view of a desired state of the fiber optic connector of FIG. 1 in the fiber optic adapter,

FIGS. 2C and 2D are section views showing when the fiber optic connector of FIG. 1 is fully inserted into the fiber optic adapter,

FIG. 3A is a perspective of the fiber optic connector according to one example of the present invention,

FIG. 3B is an exploded perspective view of the fiber optic connector of FIG. 3A,

FIG. 4A is a planar view of the fiber optic connector of FIG. 3A,

FIG. 4B illustrates the trends of changes of the first distance and second distance along the horizontal axis,

FIG. 5A is a section view of the insertion of the fiber optic connector of FIG. 3A into the adapter,

FIG. 5B is an enlarged view of the insertion of the fiber optic connector of FIG. 3A into the adapter,

FIG. 6A illustrates the fiber optic connector of FIG. 3A is inserted into the adapter in a desired state,

FIG. 6B is an enlarged view of section B of FIG. 6A,

FIG. 7 illustrates another example of the fiber optic connector in accordance with the present invention,

FIG. 8 illustrates yet another example of the fiber optic connector in accordance with the present invention,

FIG. 9A illustrates yet the other example of the fiber optic connector in accordance with the present invention,

FIG. 9B is an exploded perspective view of the fiber optic connector of FIG. 9A, and

FIGS. 10A and 10B illustrate the processes of how the conventional fiber optic connector is inserted into an adapter in accordance with the present invention.

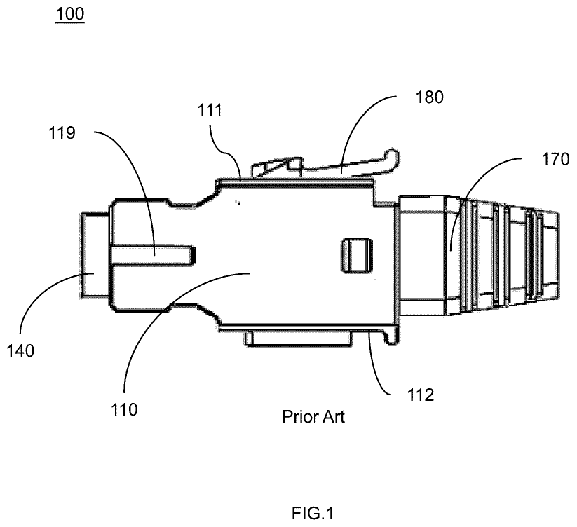

### DETAILED DESCRIPTION

This disclosure is not limited to any particular system, device and method described, as these may vary. The terminology used in the description is for the purpose of describing the examples or embodiments only and is not intended to limit the scope of the present invention. In the following description, reference is made to the accompanying drawings, and similar part numbers are used to illustrate similar parts/features.

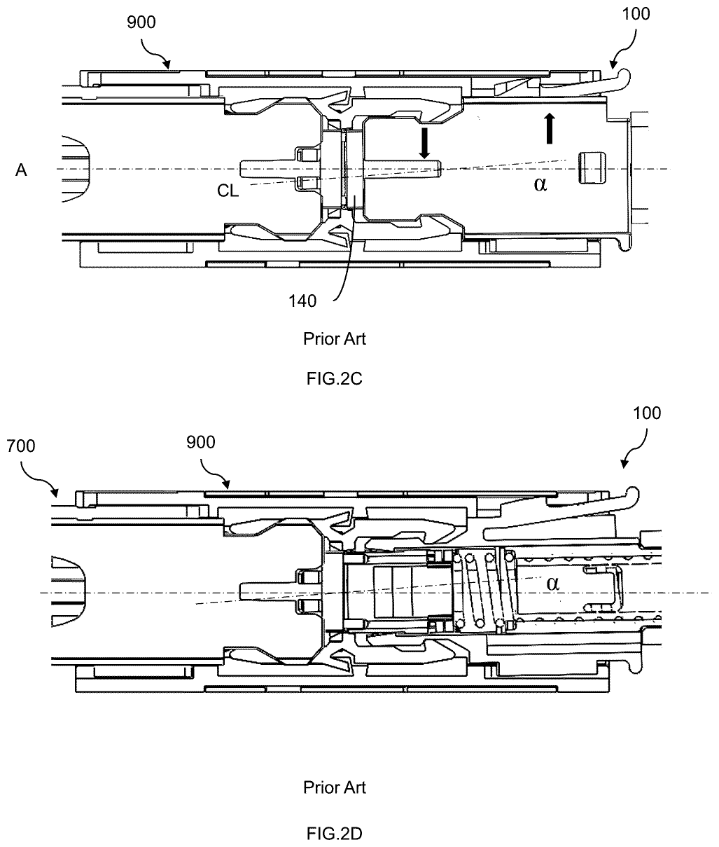

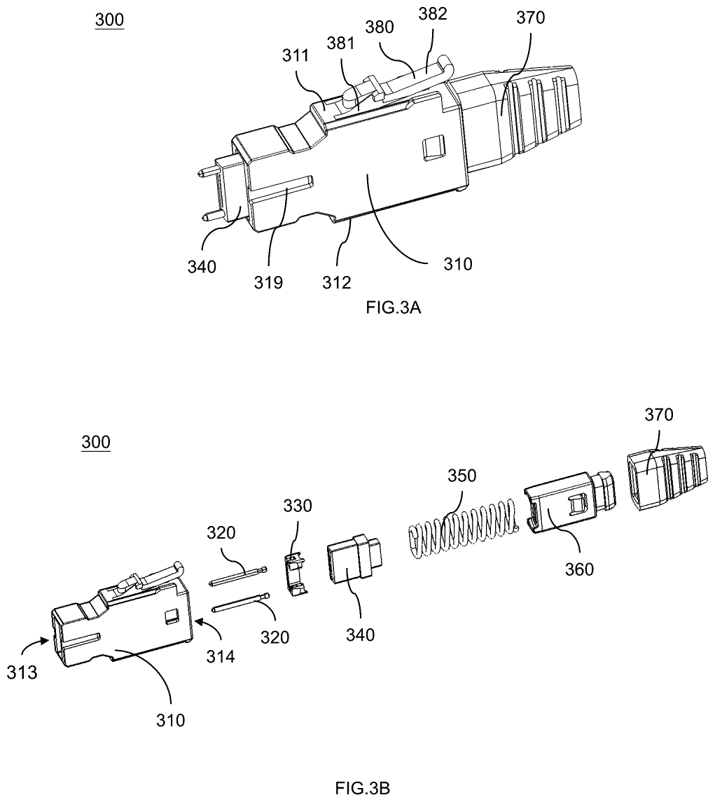

Now referring to FIGS. 3A and 3B, a fiber optic connector 300 according to one example of the present invention is shown. The fiber optic connector 300 includes a main housing 310, a ferrule 340, a spring 350 and a back post 360. The ferrule 340 received within the main housing 310 is shown as a MT (mechanical transfer) ferrule. However, those skilled in the art would understand that LC ferrule(s) could be also used. The fiber optic connector 300 may include a pair of guide pins 320 which are held by a pin keeper 330 when it's a male connector as in this example. The ferrule 340, guide pins 320 and pin keeper 330 are collectively referred to as ferrule assembly. The main housing 310 has a top surface 311 and a bottom surface 312 opposite the top surface 311 and defines a passage between the top surface and bottom surface to accommodate the ferrule assembly. A latch 380 is provided on the top surface 311 of the main housing 310 and includes a fixed end 381 connected to the top surface 311 and a free end 382 away from the top surface 311. The first distance is defined from the top surface 311 to a centerline CL of the connector 300, while a second distance is defined from the bottom surface to the centerline CL. The bottom surface 312 is provided with a key 315 (sec FIG. 4A) to guide the insertion of the connector 300.

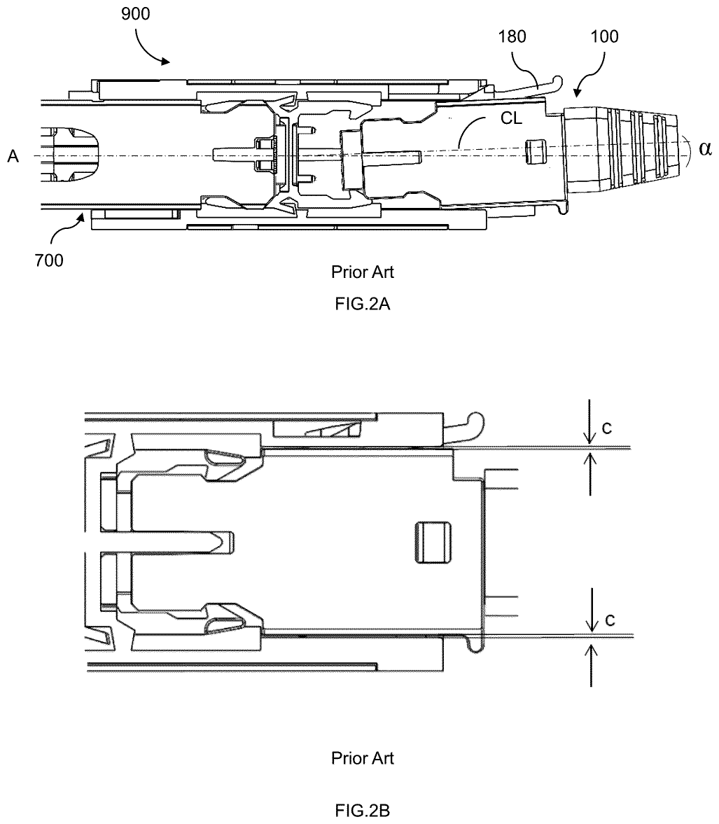

The main housing 310 has a front end 313 from which the ferrule 340 protrudes and a rear end 314 connected with the back post 360. The main housing 310 also includes a guiding recess 319 to guide the insertion of the connector 800 properly, i.e., horizontally into the adapter 900 to protect the guide pins 320. The spring 350 is provided between the ferrule 340 and the back post 360 to press against the ferrule 340 to maintain constant and reliable contact with the corresponding ferrule of the mating connector 700 as shown in FIG. 2A.

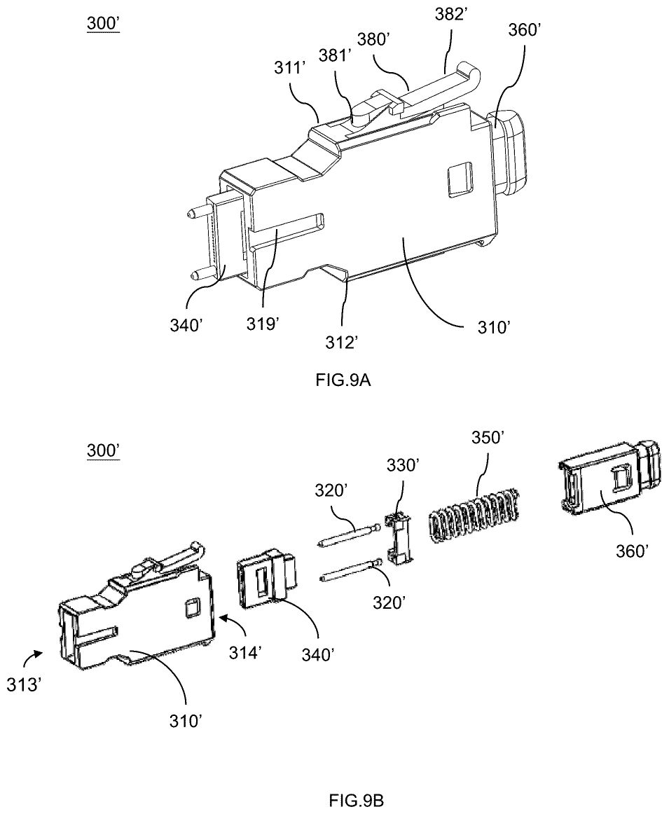

To facilitate the insertion and removal of the connector, a boot 370 is attached to the back post 360 and receives a portion of the back post 360 such that the back post 360 is not exposed outside. However, those skilled in the art could understand the boot 370 can be omitted as shown in FIGS. 9A and 9B. The fiber optic connector 300′ has a similar structure to the fiber optic connector 300 and includes a main housing 310′, guide pins 320′, pin holder 330′, ferrule 340′, spring 350′ and back post 360′. The main housing 310′ has a top surface 311′ provided with a latch 380′ and a bottom surface 312′ opposite the top surface 311′. The latch 380′ includes a fixed end 381′ connected to the top surface 311′ and a free end 382′ away from the top surface 311′. The main housing 310′ has a front end 313′ from which the ferrule 340′ protrudes and a rear end 314′ connected to the back post 360′. The back post 360′ is fitted into the rear end 314′ of the main housing 310′ and a portion of the back post 360′ is exposed outside of the main housing 310′.

To minimize the tilting of the connector resulted by the one-sided latch, an adjustment mechanism is provided to the main housing. Returning to FIG. 4A, the adjustment mechanism 390 includes a protrusion 391 provided on the top surface 311 adjacent to the rear end 314 and an inclined surface 392 on the bottom surface 312 extending towards the rear end 314. The inclined surface 392 is configured to be tapered towards the rear end 314 and cooperate with the protrusion 391 to compensate the impact caused by the asymmetric structure of the main housing 310. In detail, the second distance from the bottom surface 312 to the centerline CL varies from d2′ to d2 towards the rear end 314, in which d2′ is larger than d2. A difference k between d2′and d2 lies in the range of 0.01 mm to 1 mm, preferably in the range of 0.01 mm to 0.1 mm, 0.01 mm to 0.07 mm, 0.01 mm to 0.05 mm or 0.01 mm to 0.03 mm.

FIG. 4B illustrates how the overall distance between the top surface and bottom surface of the main housing varies along the horizontal axis. Dash-Dot line is used to illustrate the trend of the change schematically. The first distance from the top surface 311 to the centerline CL is increased from d1 to d1′ at the protrusion 391. The overall distance, i.e., sum of the first and second distances changes slightly or does not change along the horizontal axis, and the first and second distances meet the following requirements: d1=d2, d1'=d2′. In some examples, the distance d1 equals to distance d2 and to ½ height of the main housing of the conventional fiber optic connector 100. The adjustment mechanism 390 including the protrusion 391 and the inclined surface 392 is configured to enable the connector 300 to be reorientated and mated in the desired state as detailed explained below.

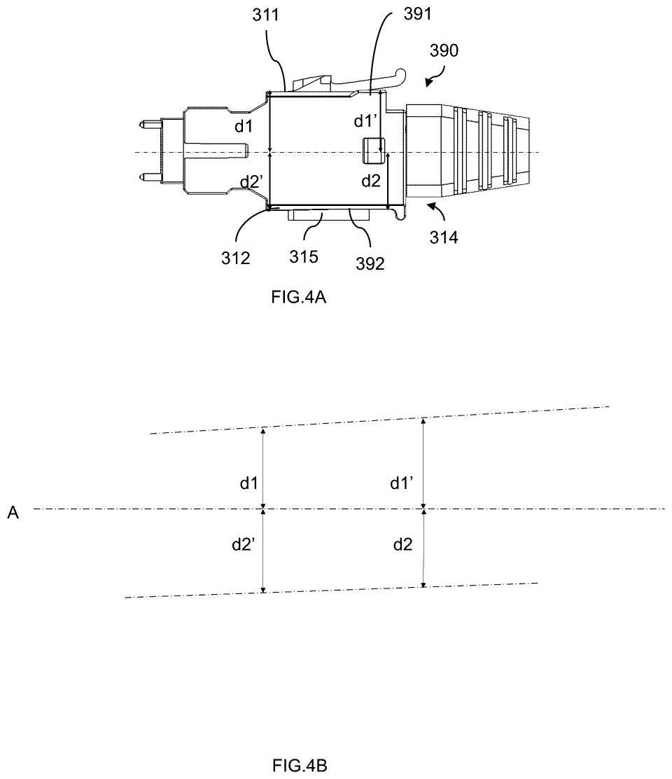

In FIG. 5A, when inserting the connector 300 into the adapter 900, the bottom surface 312 first contacts the adapter housing 910 before the latch 380 enters the adapter port, lifting the front end 313 of the main housing 310 upwards. As shown in FIG. 5B, a portion on the bottom surface 312 that first contacts the adapter housing is front portion 3921. Since the second distance d2′ is larger than the first distance d1, the front end 313 is lifted, causing an angle β to be formed between the horizontal axis A and the centerline CL. The angle β is no larger than the angle α.

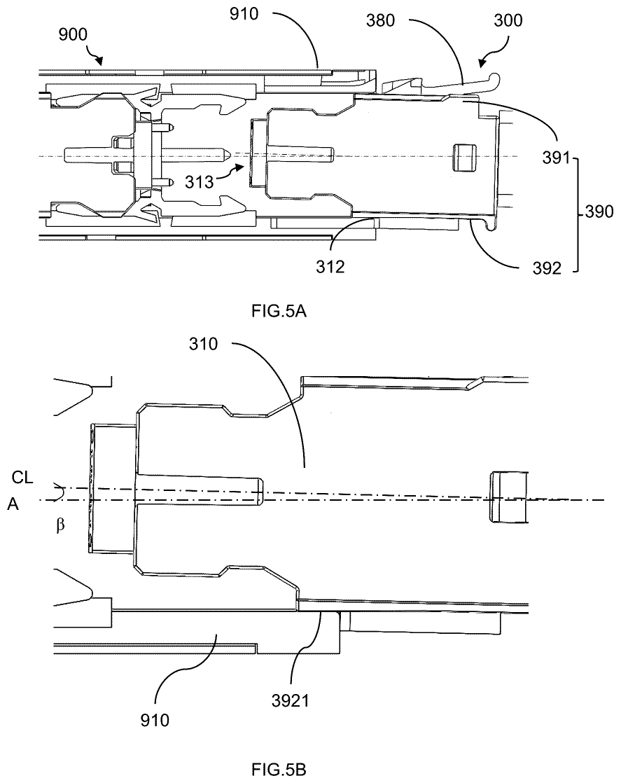

As the connector 300 moves forwards, the latch 380 enters the adapter port and hits the corresponding interior wall of the adapter housing 910. The free end 382 of the latch 380 is pressed downwards and rests upon the protrusion 391, as shown in FIG. 6B, resulting in the front end 313 moving downwards. Thus, the connector 300 is adjusted to its desired state, i.e., horizontal state, and its centerline CL overlaps with the horizontal axis A.

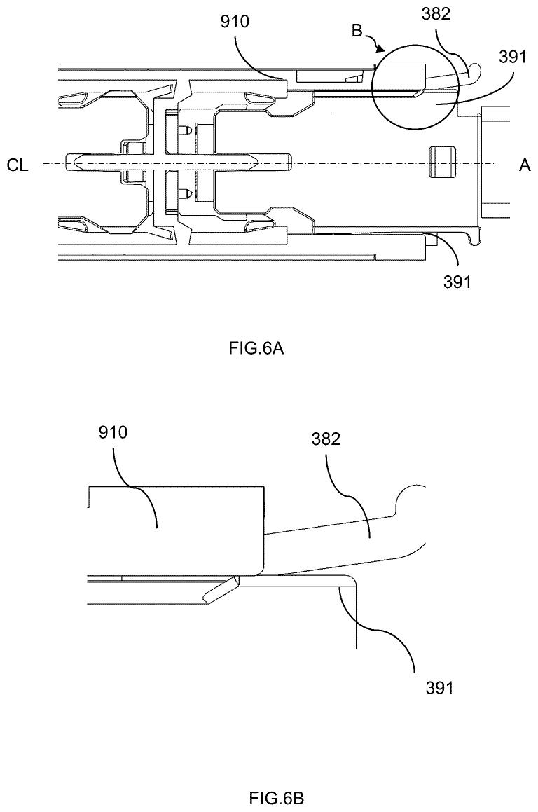

FIG. 7 shows another example of the fiber optic connector 400 in accordance with the present invention. The fiber optic connector 400 includes a main housing 410, a MT ferrule 440, and a boot 470. The boot 470 is shown for illustrative purposes only, and those skilled in the art would understand the omission of the boot 470 shall not depart from the scope and spirit of the present disclosure. The main housing 410 has a front end 413 from which the ferrule 440 protrudes and a rear end 414 attached to a back post (not shown) and boot 470. The main housing 410 includes a top surface 411 to which the latch 480 is connected and a bottom surface 412 provided with a key 415. The adjustment mechanism 490 is provided to each of the top surface 411 and bottom surface 412 and is provided with a tapered surface that the first distance changes from d1 to d1′ and second distance changes from d2′ to d2 towards the rear end 414 of the main housing 410. In this example, the first distance and second distance change inversely towards the rear end 414. In general, the overall distance does not change along the longitudinal axis.

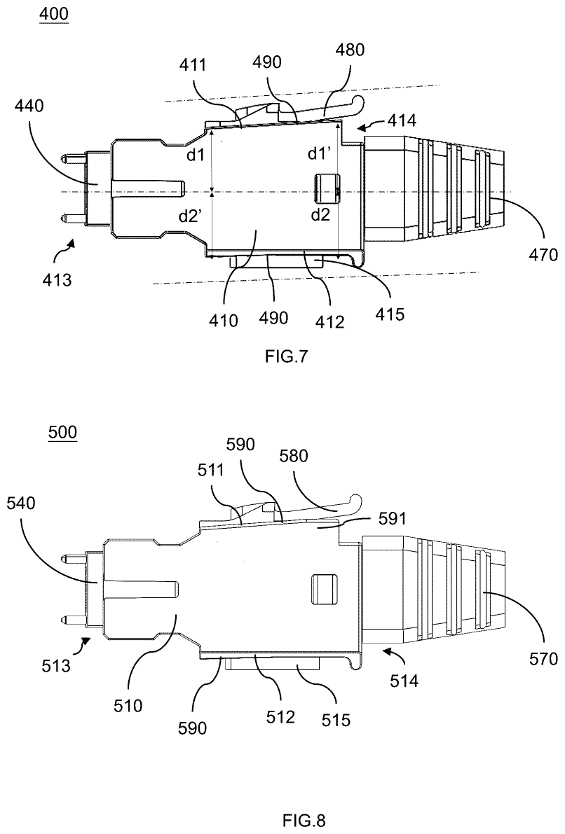

FIG. 8 shows yet another example of the fiber optic connector 500 in accordance with the present invention. The fiber optic connector 500 includes a main housing 510, a MT ferrule 540, and a boot 570. The boot 570 is shown for illustrative purposes only, and those skilled in the art would understand the omission of the boot 570 shall not depart from the scope and spirit of the present disclosure. The main housing 510 has a front end 513 from which the ferrule 540 protrudes and a rear end 514 connected to a back post (not shown) and the boot 570. The main housing 510 includes a top surface 511 to which the latch 580 is connected and a bottom surface 512 provided with a key 515. In this example, each of the top surface 511 and bottom surface 512 is provided with a tapered surface and the trends of the changes of the first distance and second distance are similar to that of the connector 400. That is, the first distance and second distance change inversely along the longitudinal axis. The top surface 511 further includes a protrusion 591 adjacent to the rear end 514 of the main housing 510.

Alternatively, to compensate for the imbalance state of the connector 100 in the adapter, the adapter 900 can be modified to minimize the titling of the connector 100 caused by the one side latch. In FIG. 9, the adapter 9000 includes a port 9300 having an entrance through which the connector 100 enters. The height at the entrance equals to the height of the connector housing 110 that is 2 H and the distance from either top surface 111 or bottom surface 112 of the connector housing 110 to the horizontal axis A is H, i.e., a half of the height at the entrance. A raised part 9110 is provided to the lower interior wall of the adapter housing 9100 close to the entrance such that the front end of the connector 100 is lifted when being inserted into the port 9300. The height of the port 9300 reduces gradually from the entrance to the raised part 9110. In specific, the height of the port 9300 is reduced by k′ in which k′ is no smaller than k.

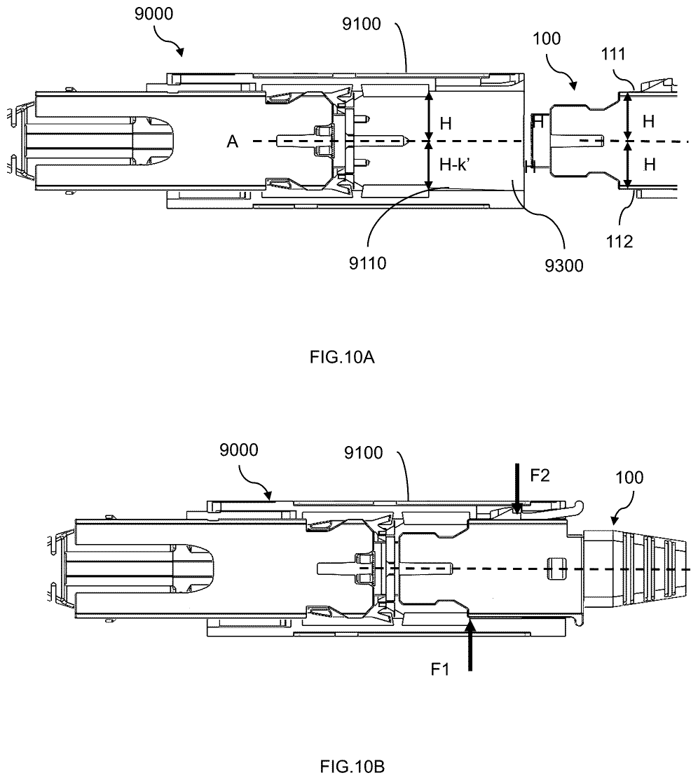

When inserting into the adapter 9000, the front end of the connector 100 is first lifted when in contact with the raise portion 9110 and then pushed downwards when the latch 180 hits the adapter housing. Thus, the connector 100 is adjusted to its desired state, i.e., horizontally, under the impacts from top and bottom of the adapter 9000 as indicated by arrows F1 and F2 shown in FIG. 10.

The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the drawings, can be altered or modified in a wide variety of different configurations, all of which are explicitly contemplated herein.

It will be understood by those within the art that the use of phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

1. A fiber optic connector comprising:
a main housing having a front end and a rear end opposite to the front end in a longitudinal direction, defining a passage extending from the front end to the rear end and having a top surface and a bottom surface;
a ferrule carrying a plurality of fibers and accommodated in the passage;
a latch provided on the top surface of the main body and configured to release the connector from an adapter port; and
a back post connected to the rear end of the main housing,
wherein the main housing includes an adjustment mechanism to ensure the connector is inserted into the adapter port in a desired state.

2. The fiber optic connector according to claim 1, wherein the adjustment mechanism includes a first adjustment part on the top surface and a second adjustment part on the bottom surface.

3. The fiber optic connector according to claim 2, wherein at least one of the first and second adjustment parts include a tapered surface.

4. The fiber optic connector according to claim 3, wherein the first adjustment part includes a protrusion on the top surface of the main body adjacent to its rear end.

5. The fiber optic connector according to claim 3, wherein the first adjustment part includes a first tapered surface, and the second adjustment part includes a second tapered surface.

6. The fiber optic connector according to claim 5, wherein a first distance is defined between the top surface and a centreline of the connector, and a second distance is defined between the bottom surface and the centreline of the connector, wherein the first distance and second distance change inversely along the longitudinal direction.

7. The fiber optic connector according to claim 5, wherein each of the first and tapered surface extend towards the rear end of the main housing.

8. The fiber optic connector according to claim 5, wherein the first tapered surface includes a protrusion portion adjacent to the rear end of the main housing.

9. The fiber optic connector according to claim 5, wherein a sum of the first distance and second distance remains unchanged along the longitudinal direction.

10. The fiber optic connector according to claim 4, wherein the protrusion has a height corresponding to a variation of the tapered surface.

11. The fiber optic connector according to claim 1, wherein one portion of the back post is received in the passage of the main housing and the remainder portion of the back post is exposed outside.

12. The fiber optic connector according to claim 1, wherein the connector includes a spring between the ferrule and the back post.

13. The fiber optic connector according to claim 1, wherein the ferrule includes a MT ferrule or LC ferrule.

14. The fiber optic connector according to claim 1, wherein the connector includes a pair of guide pins.

15. The fiber optic connector according to claim 1, wherein the main housing includes at least one guiding recess on its exterior surface.

16. The fiber optic connector according to claim 1, wherein the main housing includes at least one recess on its top or bottom side.

17. The fiber optic connector according to claim 1, wherein the connector includes a boot configured to be attached to the main housing and receive a portion of the back post therein.
